(19) United States
(12) Patent Application Publication
(10) Pub. No.: US 2007/0176593 A1
(43) Pub. Date: Aug. 2, 2007

(54) Transmission sensor with overmolding and method of manufacturing the same

(76) Inventor: Paul Fathauer, Sullivan, IN (US)

Correspondence Address: KRIEG DEVAULT LLP, ONE INDIANA SQUARE, SUITE 2800, INDIANAPOLIS, IN, 46204-2079, US

(21) Appl. No.: 11/343,959

(22) Filed: Jan. 31, 2006

(51) Int. Cl. G01P 3/46

(52) U.S. Cl. 324/163

(57) ABSTRACT

A sensor including a bobbin including a first region adapted to receive windings and a second region defining a cavity formed in the bobbin. A first electrical terminal is coupled to the bobbin and disposed in the cavity and a second electrical terminal is coupled to the bobbin and disposed in the cavity. A wire including a wound portion wound about the first region. The wire is conductively coupled to the first terminal and the second terminal to provide an electrically conductive pathway from the first terminal to the second terminal. A magnetizable core is disposed at least partially within the wound portion and a magnet is positioned adjacent the magnetizable core. An overmolded shell defining an exterior surface of the sensor encapsulates at least the first region and the wound portion and contacts at least the wound portion.

### TECHNICAL FIELD

The technical field relates to sensors for use in an automatic transmission of a motor vehicle and in particular to threaded transmission sensors for measuring the rotational speed of an input shaft or an output shaft.

### BACKGROUND

With the advance of improved controls for automatic transmission operation, the use of various electrical actuators and sensors has expanded greatly. Therefore, automotive electrical components such as transmission speed sensors have become high volume components within the automotive industry. Because such parts may experience failure within the operating life of the automobile, many of these components are offered through the aftermarket industry. Failure rates are affected by the type of part and the design. For example, the electromagnetic phenomenon of variable reluctance is commonly utilized in speed sensors. Typically, in such a sensor, a permanent magnet coupled with a wound coil is located in close proximity to a ferrous rotating member with teeth. As the magnetic field couples and decouples with each tooth on the member, an electrical signal is generated that varies in frequency depending on the angular speed of the member. Generally, this signal is remotely processed by a controller along with other inputs such as engine load, for controlling shifting of the transmission. U.S. Pat. No. 4,586,401 describes one example of such an automatic transmission control scheme. Variable reluctance sensors are often used in these applications because of the reliability of the signal that they output (i.e., low signal noise). However, such transmission sensors, including threaded speed sensors, may become inoperative because of various failure modes. This can occur even prior to damage or decay to the external covering of the sensor. The present invention addresses these and other problems associated with prior art sensors.

One example of such a sensor is the output speed sensor (P/N 0400879) used in several Chrysler transmissions including the A604. This prior art sensor 39 is shown in an exploded view in FIG. 35. Sensor 39 includes shell 40 having threads 41, stopping flange 42, and tip 46. Sensor 39 further includes bobbin assembly 50 having magnet 54, pole piece 53, wound copper wire 52, bobbin 51, and pins 55. Sensor 39 is assembled as follows. Shell 40 is independently formed as a single piece using injection molding. Wire 52 is wound on bobbin 51 and the ends of wire 52 are soldered to pins 55. Pole piece 53 is inserted into the bobbin assembly 50 and magnet 54 is placed at the end of pole piece 53. Bobbin assembly 50 is then advanced into shell 40 in the direction indicated by arrow I so that magnet 54 pole piece 53, wire 42 and pins 55 are positioned inside a cylindrical cavity formed inside shell 40. Assembly is completed by bending a holding flange over the inserted bobbin assembly. Bending of the holding flange may be accomplished by using heat and pressure to bend the thin holding flange without breaking the plastic. The heat can be applied using convection, conduction or ultrasound. A similar prior art sensor is the input speed sensor (P/N 0400878) also used in several Chrysler transmissions including the A604.

With reference to FIG. 36 there is shown a top view of shell 40. Identical reference numerals are used to indicate portions of shell 40 described above. Additionally, there is shown cylindrical cavity 43 including side surface 44 and tip cavity 45. As described above, bobbin assembly 50 is advanced into cavity 43 during assembly of sensor 39. In the assembled state, magnet 54 and an end portion of pole piece 53 are positioned in tip cavity 45, and the rest of pole piece 53, wire 52, pins 55 and a portion of bobbin 51 are positioned in cavity 43.

### SUMMARY

One embodiment according to the present invention includes a sensor including a bobbin including a first region adapted to receive windings and a second region defining a cavity formed in the bobbin is disclosed. A first electrical terminal is coupled to the bobbin and disposed in the cavity and a second electrical terminal is coupled to the bobbin and disposed in the cavity. A wire including a wound portion wound about the first region of the wire is conductively coupled to the first terminal and the second terminal to provide an electrically conductive pathway from the first terminal to the second terminal. A magnetizable core is disposed at least partially within the wound portion and a magnet is positioned adjacent the magnetizable core. An overmolded shell defining an exterior surface of the sensor encapsulates at least the first region and the wound portion and contacting at least the wound portion.

Another embodiment according to the present invention includes a method of manufacturing a sensor. The method includes providing an assembly. The assembly includes a bobbin having a cavity, a wire including a wound portion wound about the bobbin, a magnetizable core disposed at least partially within the wound portion, and a magnet positioned adjacent the magnetizable core. The method further includes inserting a plug into the cavity, positioning the plug and the assembly into a mold, introducing resin into the mold effective encapsulate the sensor assembly, first removing the plug and the assembly from the mold, and second removing the plug.

A further embodiment according to the present invention includes a method of overmolding a resin shell about a variable reluctance sensor assembly. The assembly includes a bobbin, a conductor wound about the bobbin, and an aperture defined at an end of the bobbin. The method includes connecting a positioning tool to the assembly at the aperture, placing the assembly and the positioning tool in a mold, maintaining the position of the assembly using the tool, introducing resin into the mold, and allowing the resin to set. The introducing is effective to substantially hermetically encapsulate a portion of the assembly excluding the aperture and is further effective to form an outermost surface of the sensor.

It is one object of the present invention to provide an improved transmission sensor.

It is another object of the invention to provide a transmission sensor that preferably has a longer component life than at least some products currently available on the market.

Additional embodiments, aspects, and advantages of the present invention will be apparent from the following description and claims.

### BRIEF DESCRIPTION OF THE FIGURES

FIG. 1 is a side view of an embodiment of an output sensor of the present invention.

FIG. 2 is an enlarged detail view of Section 2 of FIG. 1.

FIG. 3 is a side view of the embodiment of FIG. 1 rotated 90°.

FIG. 4 is a top view of the embodiment of FIG. 3.

FIG. 5 is an enlarged detail view of Section 5 of FIG. 3.

FIG. 6 is an enlarged detail view of Section 6 of the embodiment of FIG. 3.

FIG. 7 is a top view of the embodiment of FIG. 6.

FIG. 8 is a cross-sectional view of the embodiment of FIG. 1 along the lines 8-8.

FIG. 9 is an enlarged detail view of Section 9 of FIG. 8.

FIG. 10 is a rotated perspective view of the embodiment of the invention illustrated in FIG. 1.

FIG. 11 illustrates a side view of a embodiment of an input sensor of the present invention.

FIG. 12 is an enlarged detail view of Section 12 of FIG. 11.

FIG. 13 is a side view of the embodiment of FIG. 11 rotated 90°.

FIG. 14 is a top view of the embodiment of FIG. 13.

FIG. 15 is an enlarged detail view of Section 15 of FIG. 13.

FIG. 16 is an enlarged detail view of Section 16 of the embodiment of FIG. 13.

FIG. 17 is a top view of the embodiment of FIG. 16.

FIG. 18 is a cross-sectional view of the embodiment of FIG. 11 along the lines 18-18.

FIG. 19 is an enlarged detail view of Section 19 of FIG. 18.

FIG. 20 is a rotated perspective view of the embodiment of the invention illustrated in FIG. 11.

FIG. 21 is a side view of one embodiment of a locating cap of the present invention.

FIG. 22 is a top view of the embodiment of FIG. 21.

FIG. 23 is a cross-sectional view of the embodiment of FIG. 21 along the lines 23-23.

FIG. 24 is an elevated side perspective view of the embodiment of FIG. 21.

FIG. 25 is another elevated side perspective view of the embodiment of FIG. 21.

FIG. 26 is a top view of another embodiment of a locating cap of the present invention.

FIG. 27 is a cross-sectional view of the embodiment of FIG. 26 along the lines 27-27.

FIG. 28 is an enlarged detail view of Section 28 of the embodiment of FIG. 27.

FIG. 29 is a side view of the embodiment of FIG. 26.

FIG. 30 is an elevated side perspective view of the embodiment of FIG. 26.

FIG. 31 is a side view of one embodiment of the locator plug for holding the sensor in the mold.

FIG. 32 is the side view of the embodiment of FIG. 31 with added detail concerning various dimensions of this embodiment of the locator plug.

FIG. 33 is an enlarged end view of the embodiment of FIG. 32.

FIG. 34 is a flow diagram according to an embodiment of the present invention.

FIG. 35 is an exploded view of a prior art sensor.

FIG. 36 is a top view of the shell of the sensor of FIG. 36.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The inventor has determined that the design and assembly of sensors such as prior art sensor 39 contributes to a high failure rate in the field. The inventor has determined that approximately 90% of the failure rate is due to wire failure. In prior art sensors some or all of the wire is unsupported and exposed after insertion in to the shell cavity within the sensor. Heat, vibration and/or corrosion can lead to fatigue failure of the wire. This creates an open circuit coil that will not generate a signal. Such a failure will create shifting problems in the transmission, as the controller has to default to open-loop control of the unit.

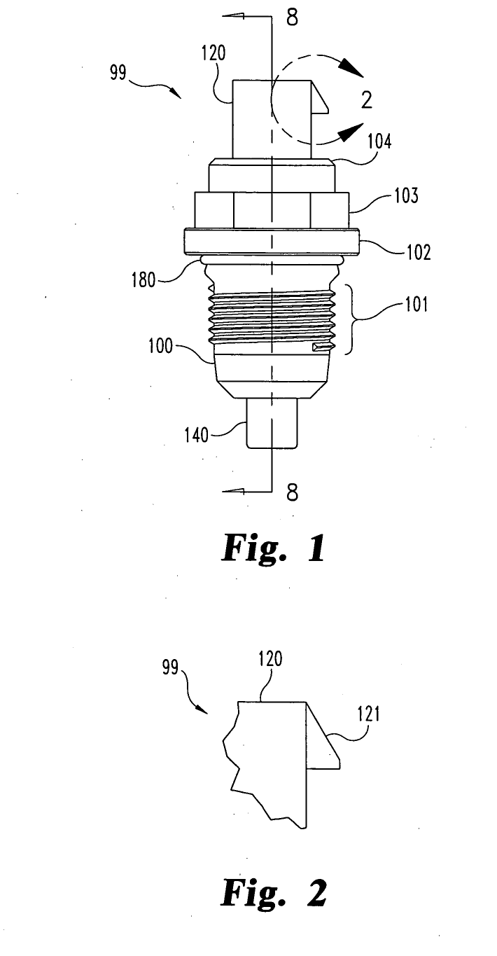

With reference to FIGS. 1-10 there are shown multiple views of an output transmission sensor according to a preferred embodiment of the present invention. FIG. 1 shows output sensor 99 which is a threaded variable reluctance sensor for sensing the rotational speed of the output shaft of an automatic transmission. Output sensor 99 includes bobbin 120 and centering cap 140 which are partially encapsulated by overmolded resin shell 100. Shell 100 includes threads 101, stopping flange 102, hexagonal section 103, and top section 104. Output sensor 99 also preferably includes O-ring 180.

Sensor 99 is preferably adapted to be installed in a threaded bore formed in the housing of an automatic transmission near a toothed ferrous rotating ring associated with the output shaft of an automatic transmission. Installation of Sensor 99 can be accomplished by advancing sensor 99 into the bore until threads 101 contact threads formed on the interior of the bore. A tool can then be used to engage hexagonal section 103 and rotate sensor 99 to cause threads 101 to engage the threads of the bore and advance sensor 99 into the bore. Sensor 99 is preferably rotated until a stopping flange 102 contacts the outside of the transmission housing and a seal is formed between sensor 99 and the housing by stopping flange 102 and O-ring 180. Sensor 99 is then preferably torqued down to a particular force to prevent back out.

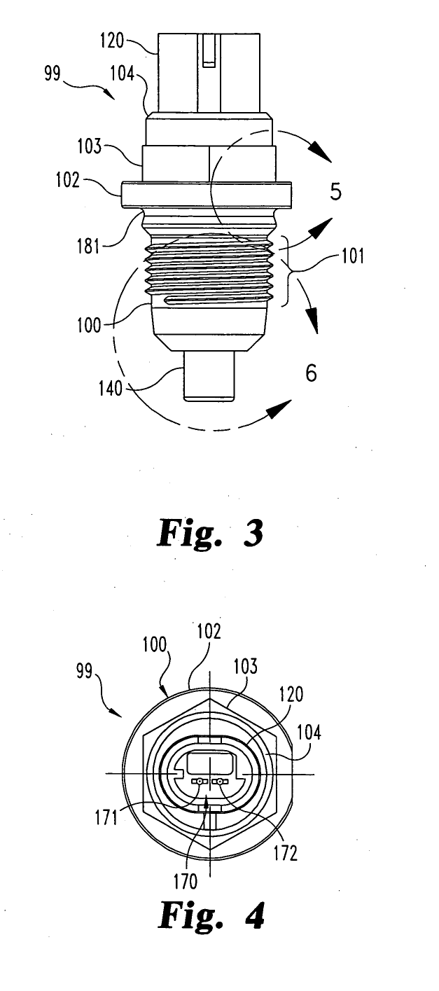

With reference to FIGS. 2-10 there are shown additional views of sensor 99. Identical reference numerals are used to indicate aspects of sensor 99 described above. Additional aspects of sensor 99 are as follows. FIG. 2 shows a detailed view of the portion of output sensor 99 indicated by arrows 2 in FIG. 1. A portion of the terminal connection end of bobbin 120 is shown in FIG. 2 which includes fastener 121. Fastener 121 is adapted to releasably engage a clip of a plug of an electrical cable that connects to terminal connection end of bobbin 120.

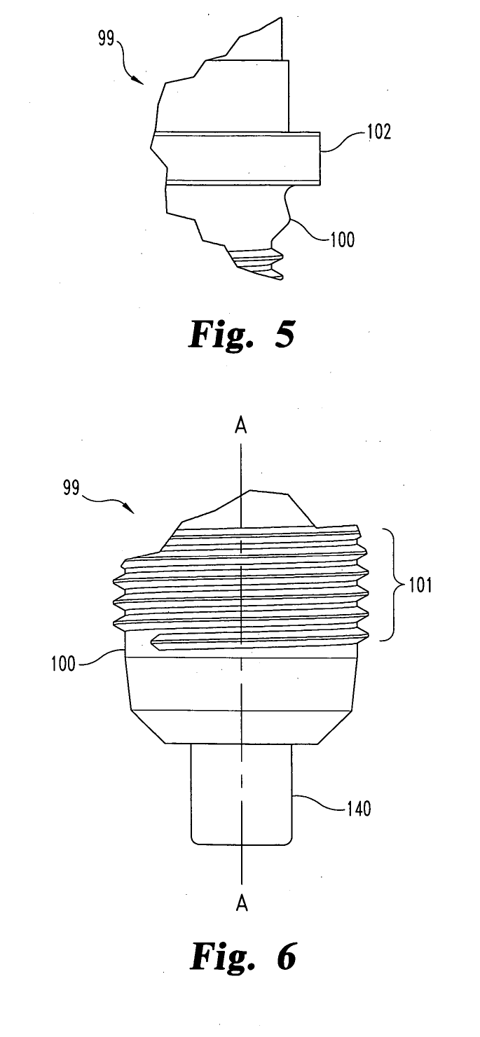

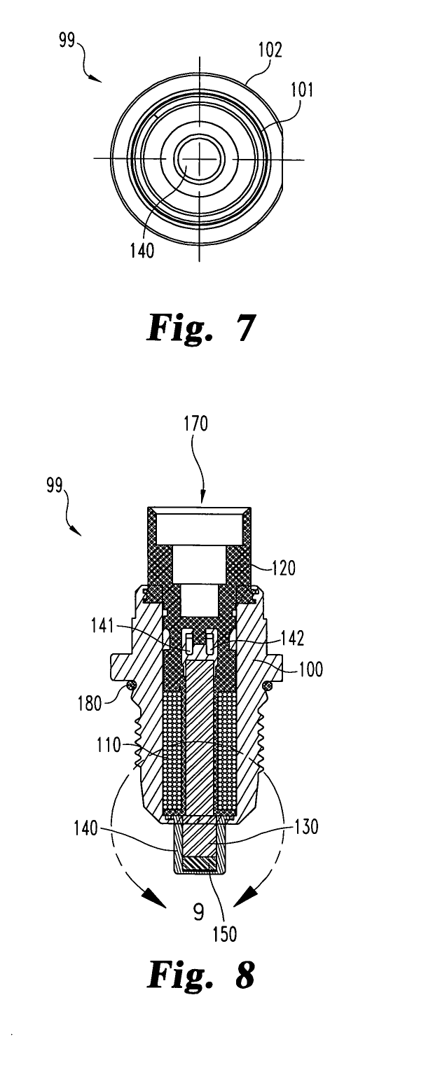

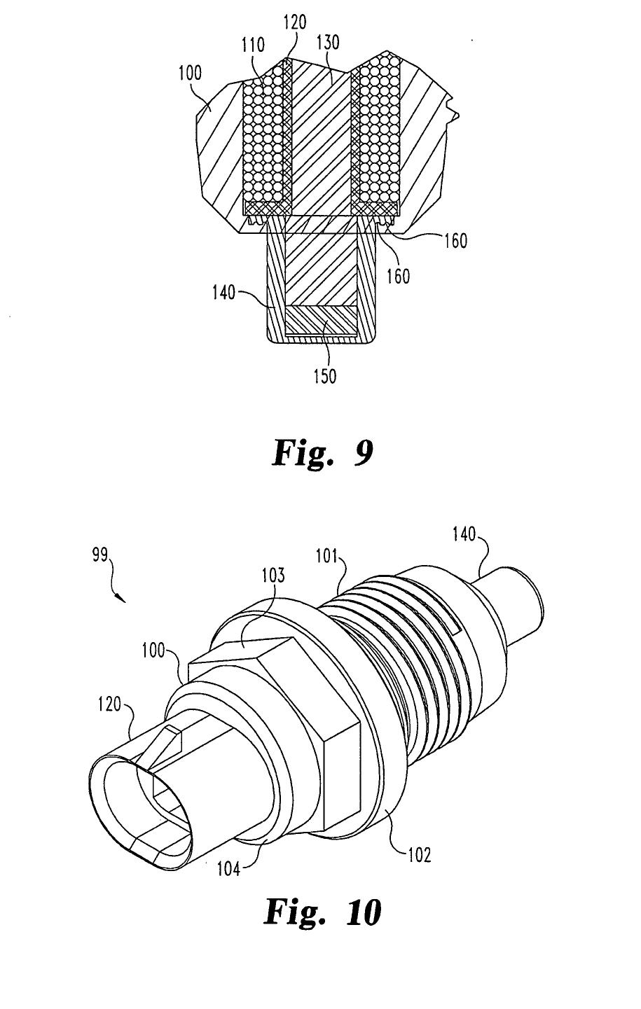

FIG. 3 shows sensor 99 with O-ring 180 removed and O-ring seat 181 visible. FIG. 4 shows cavity 170 formed in the terminal connection end of sensor 99. Terminals 171 and 172 are disposed within cavity 170 and are electrically interconnected to a wire wound around a portion of the bobbin 120 within sensor 99 as shown and described below in connection with FIGS. 8 and 9. During operation a plug of an electrical cable can be inserted into terminal cavity 170 to establish electrical connections with terminals 171 and 172. In an alternative embodiment, instead of including terminals disposed within a cavity, sensor 99 includes lead wires extending from its end which lead to a plug connector remote from the body of bobbin 120. These wires can be positioned outside a mold during the overmolding process used to form shell 100 which is described in greater detail below. Overmolded shell 100 can extend to and encapsulate the junction between the lead wires and bobbin 120, or can extend along bobbin 120 to an area before the junction. FIG. 5 shows an enlarged detailed view of the portion of sensor 99 indicated by arrow 5 in FIG. 3. FIG. 6 shows an enlarged detailed view of the portion of sensor 99 indicated by arrow 6 in FIG. 3. FIG. 7 shows a bottom view of sensor 99.

FIG. 8 shows a side sectional view of sensor 99. FIG. 8 shows wire 110 wound around bobbin 120. One end portion of wire 110 extends from the windings and is electrically interconnected to pin terminal 141, for example by soldering, and another end of wire 110 similarly extends from the windings and is electrically interconnected with pin terminal 142. Pin terminals 141 and 142 are electrically interconnected with terminals 171 and 172 through a conductive pathway routed through bobbin 120. As shown in FIG. 8, overmolded resin shell 100 contacts portions of bobbin 120, wire 110 and portions of cap 140. Shell 100 preferably contacts and supports wire 110 at its windings and further preferably contacts and supports portions of wire 110 extending between the windings around bobbin 120 and the pin terminals 141 and 142. FIG. 9 shows a detailed view of the portion of sensor 99 indicated by arrows 9 in FIG. 8. As shown in FIG. 9, sealing rings 160 are formed in cap 140 and overmolded resin shell 100 fills sealing rings 160. Contact between shell 100 and cap 140 preferably forms a hermetic seal between the interior of sensor 99 and the exterior environment. FIG. 10 shows a perspective view of sensor 99.

A preferred embodiment of sensor 99 according to the present invention can be manufactured according to dimensions and tolerances specified for use in connection with a variety of automatic transmissions from a variety of manufacturers including, for example, the dimensions of part number 0400879 which was mentioned above. These dimensions and tolerances are merely exemplary of one preferred embodiment, however, and sensors of a variety of different configurations, sizes, dimensions, and tolerances are contemplated as within the scope of the invention including, for example, dimensions and tolerances for sensors adapted for use in other automatic transmissions and those adapted for use in other applications and environments where it is desirable or useful to obtain information relating to the rotational speed of a toothed ring or other rotating structure.

According to a preferred embodiment of the present invention, overmolded resin shell 100 is preferably formed from a resin material adapted for use in an injection molding system, most preferably of Zytel #70G43L NC010 resin which is a 43% glass filled, natural colored polyamide 6/6 grade nylon material available from DuPont corporation of Wilmington, Del. It is also contemplated that shell 100 could be formed from a variety of other materials, for example, other grades of Zytel with different glass contents, copolymers or colors, 4/6 grades of polyamide such as DSM Stanyl TW241F10 or others, other members of the polyamide family of resins including other 4/6 and 6/6 grades, other materials having similar properties, other plastics, thermoplastics, epoxy resins, and/or other materials suitable to maintain their integrity in an injection molding environment.

According to a preferred embodiment of the present invention, wire 110 is preferably NEMA MW79-C which is a copper wire with polyurethane coating and is rated to 155 degrees Celsius. Wire 110 could also be a variety of other conductive materials including, for example, NEMA MW82C or 83C, or any other type of wire suitable for hermetic overmolding applications. A preferred embodiment according to the present invention includes 6200 turns or windings of wire 110 which gives a coil resistance of about 650 Ohms+/−about 10%. This number of windings and resistance are merely exemplary, however, and a variety of numbers of windings and resistances are contemplated as within the scope of the present invention.

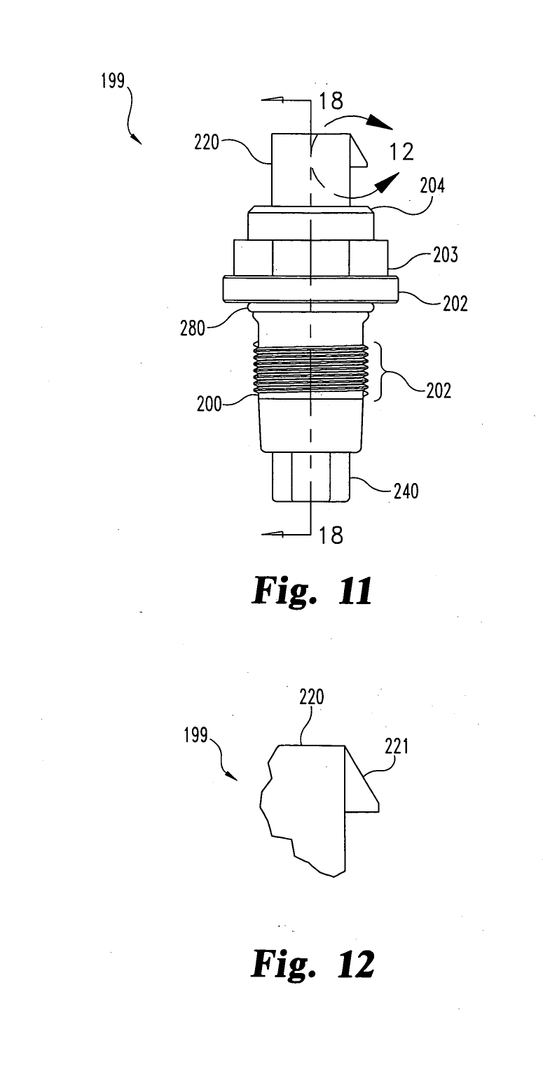

With reference to FIGS. 11-20 there are illustrated multiple views of an input transmission sensor according to one embodiment of the present invention. FIG. 11 shows input sensor 199 which is a threaded variable reluctance sensor for sensing the rotational speed of the input shaft of an automatic transmission. Input sensor 199 includes bobbin 220 and centering cap 240 which are hermetically encapsulated by overmolded resin shell 200. Shell 200 includes threads 201, stopping flange 202, hexagonal section 203, and top section 204. Input sensor 199 also preferably includes O-ring 280.

Sensor 199 is preferably adapted to be installed in a threaded bore formed in the housing of an automatic transmission near a toothed ferrous rotating ring associated with the input shaft of an automatic transmission. Installation of sensor 199 can be accomplished by advancing sensor 199 into the bore until threads 201 contact threads formed on the interior of the bore. A tool can then be used to engage hexagonal section 203 and rotate sensor 199 to cause threads 201 to engage the threads of the bore and advance sensor 199 into the bore. Sensor 199 is preferably rotated until stopping flange 202 contacts the outside of the transmission housing and a seal is formed between sensor 199 and the housing by stopping flange 202 and O-ring 280. Sensor 199 is preferably torqued down to a particular force to prevent back out.

With reference to FIGS. 12-20 there are shown additional views of sensor 199. Identical reference numerals are used to indicate aspects of sensor 199 described above. Additional aspects of sensor 199 are as follows. FIG. 12 shows a detailed view of the portion of input sensor 199 indicated by arrows 12 in FIG. 11. A portion of the terminal connection end of bobbin 220 is shown in FIG. 12 which includes fastener 221. Fastener 221 is adapted to releasably engage a clip of a plug of an electrical cable that connects to terminal connection end of bobbin 220.

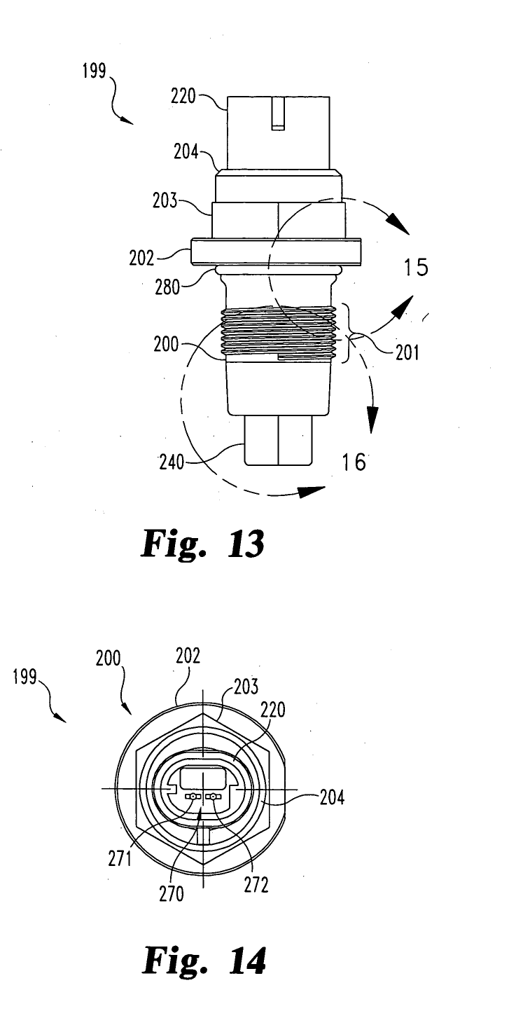

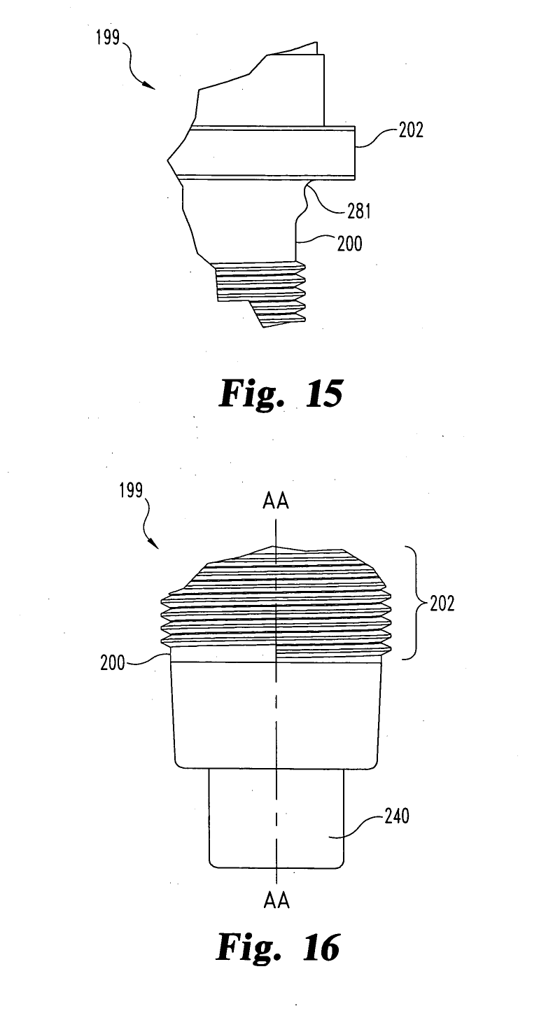

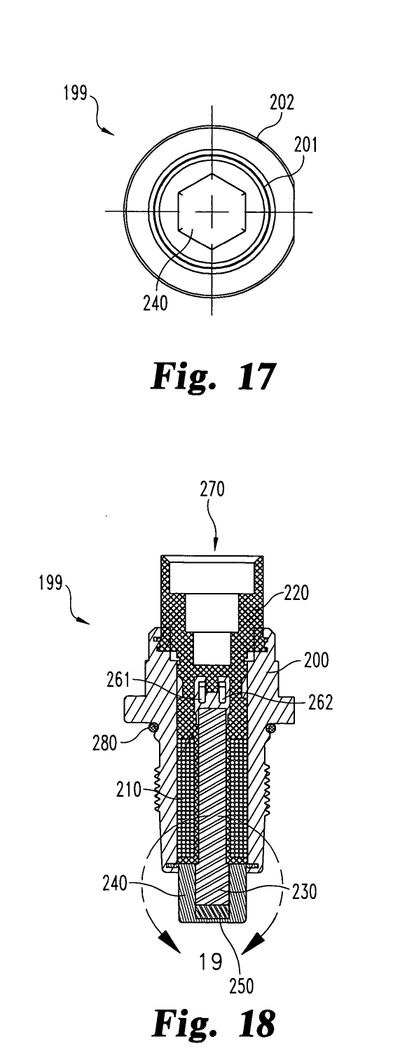

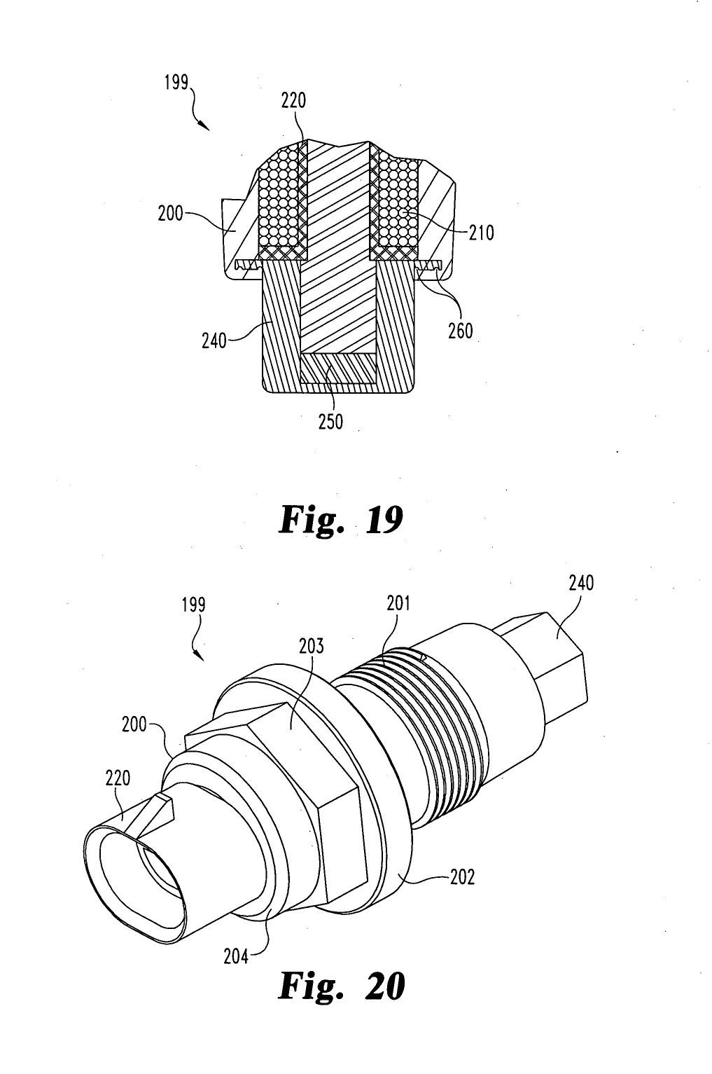

FIG. 13 shows a side view of sensor 199 rotated 90 degrees. FIG. 14 shows cavity 270 formed in the terminal connection end of sensor 199. Terminals 271 and 272 are disposed within cavity 270 and are electrically interconnected to a wire wound around a portion of the bobbin 220 within sensor 199 as shown and described below in connection with FIGS. 18 and 19. During operation a plug of an electrical cable can be inserted into terminal cavity 270 to establish electrical connections with terminals 271 and 272. In an alternative embodiment, instead of including terminals disposed within a cavity, sensor 199 includes lead wires extending from its end which lead to a plug connector remote from the body of bobbin 220. These wires can be positioned outside a mold during the overmolding process used to form shell 200 which is described in greater detail below. Overmolded shell 200 can extend to and encapsulate the junction between the lead wires and bobbin 220, or can extend along bobbin 220 to an area before the junction. FIG. 15 shows an enlarged detailed view of the portion of sensor 199 indicated by arrow 15 in FIG. 13. FIG. 15 shows a portion of sensor 199 with O-ring 280 removed and O-ring seat 281 visible. FIG. 16 shows an enlarged detailed view of the portion of sensor 199 indicated by arrow 16 in FIG. 13. FIG. 17 shows a bottom view of sensor 199.

FIG. 18 shows a side sectional view of sensor 199. FIG. 8 shows wire 210 wound around bobbin 220. One end portion of wire 210 extends from the windings and is electrically interconnected to pin terminal 261, for example by soldering, and another end of wire 210 similarly extends from the windings and is electrically interconnected with pin terminal 262. Pin terminals 261 and 262 are electrically interconnected with terminals 271 and 272 through a conductive pathway routed through bobbin 220. As shown in FIG. 18, overmolded resin shell 200 contacts portions of bobbin 220, wire 210 and portions of cap 240. Shell 200 preferably contacts and supports wire 210 at its windings and further preferably contacts and supports portions of wire 210 extending between the windings around bobbin 220 and the pin terminals 261 and 262. FIG. 19 shows a detailed view of the portion of sensor 199 indicated by arrows 19 in FIG. 18. As shown in FIG. 19, sealing rings 260 are formed in cap 240 and overmolded resin shell 200 fills sealing rings 260. Contact between shell 200 and cap 240 preferably forms a hermetic seal between the interior of sensor 199 and the exterior environment. FIG. 20 shows a perspective view of sensor 199.

A preferred embodiment of sensor 199 according to the present invention can be manufactured according to dimensions and tolerances specified for use in connection with a variety of automatic transmissions from a variety of manufacturers including, for example, the dimensions of part number 0400879 which was mentioned above. These dimensions and tolerances are merely exemplary of one preferred embodiment, however, and sensors of a variety of different configurations, sizes, dimensions, and tolerances are contemplated as within the scope of the invention including, for example, dimensions and tolerances for sensors adapted for use in other automatic transmissions and those adapted for use in other applications and environments where it is desirable or useful to obtain information relating to the rotational speed of a toothed ring or other rotating structure.

According to a preferred embodiment of the present invention, overmolded resin shell 200 is preferably formed from a resin material adapted for use in an injection molding system, most preferably of Zytel #70G43L NC010 resin which is a 43% glass filled, natural colored polyamide 6/6 grade nylon material available from DuPont corporation of Wilmington, Del. It is also contemplated that shell 200 could be formed from a variety of other materials, for example, other grades of Zytel with different glass contents, copolymers or colors, 4/6 grades of polyamide such as DSM Stanyl TW241F10 or others, other members of the polyamide family of resins including other 4/6 and 6/6 grades, other materials having similar properties, other plastics, thermoplastics, epoxy resins, and/or other materials suitable to maintain their integrity in an injection molding environment.

According to a preferred embodiment of the present invention, wire 210 is preferably NEMA MW79-C which is a copper wire with polyurethane coating and is rated to 155 degrees Celsius. Wire 110 could also be a variety of other conductive materials including, for example, NEMA MW82C or 83C, or any other type of wire suitable for hermetic overmolding applications. A preferred embodiment according to the present invention includes 6350 turns or windings of wire 210 which gives a coil resistance of about 760 Ohms+/−about 10%. This number of windings and resistance are merely exemplary, however, and a variety of numbers of windings and resistances are contemplated as within the scope of the present invention.

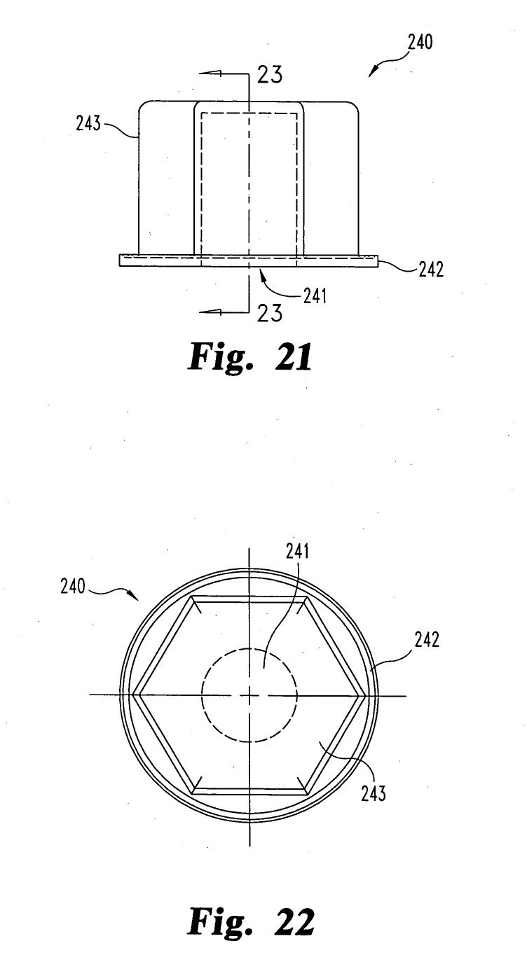

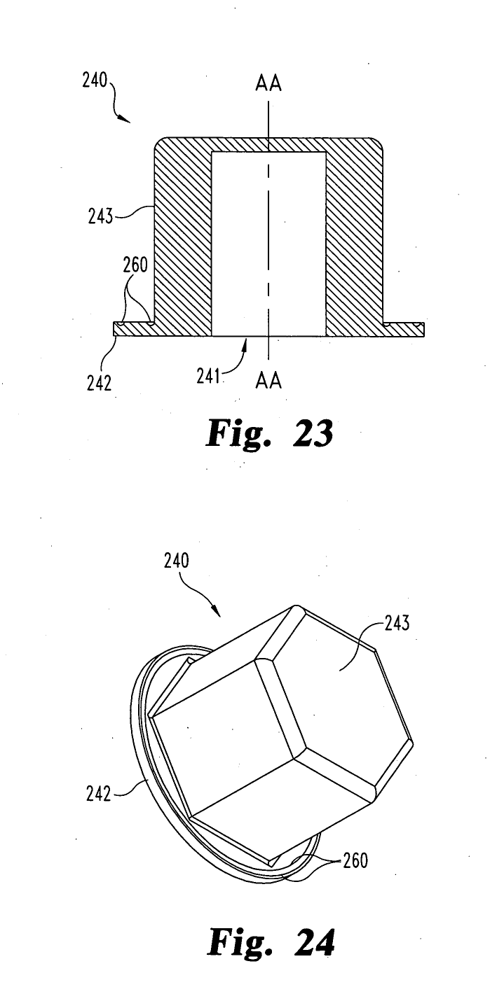

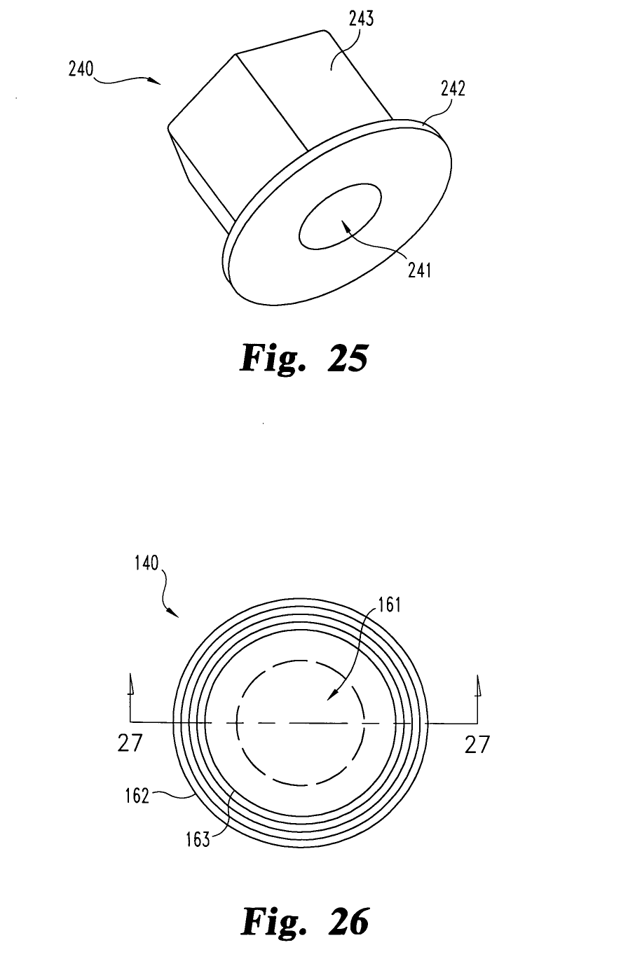

With reference to FIGS. 21-25 there are shown multiple views of centering cap 240 which is also illustrated and described above in connection with FIGS. 11-20. As shown in FIGS. 21-25 cap 240 includes cap body 243, cap flange 242, sealing rings 260, and cap cavity 241. Cap cavity 241 receives magnet 250 and an end portion of pole piece 230, as illustrated and described above. Cap body 243 has a generally hexagonal cross sectional shape and cap flange 242 and cap cavity 241 have generally circular cross sectional shapes for sections taken perpendicular to axis AA shown in FIG. 23.

A preferred embodiment of cap 240 according to the present invention can be manufactured to dimensions and tolerances which allow magnet 250 and an end portion of pole piece 230 to fit snugly within cavity 241. These dimensions and tolerances are merely exemplary of one preferred embodiment, however, and centering caps of a variety of different configurations, sizes, dimensions, and tolerances are contemplated as within the scope of the invention.

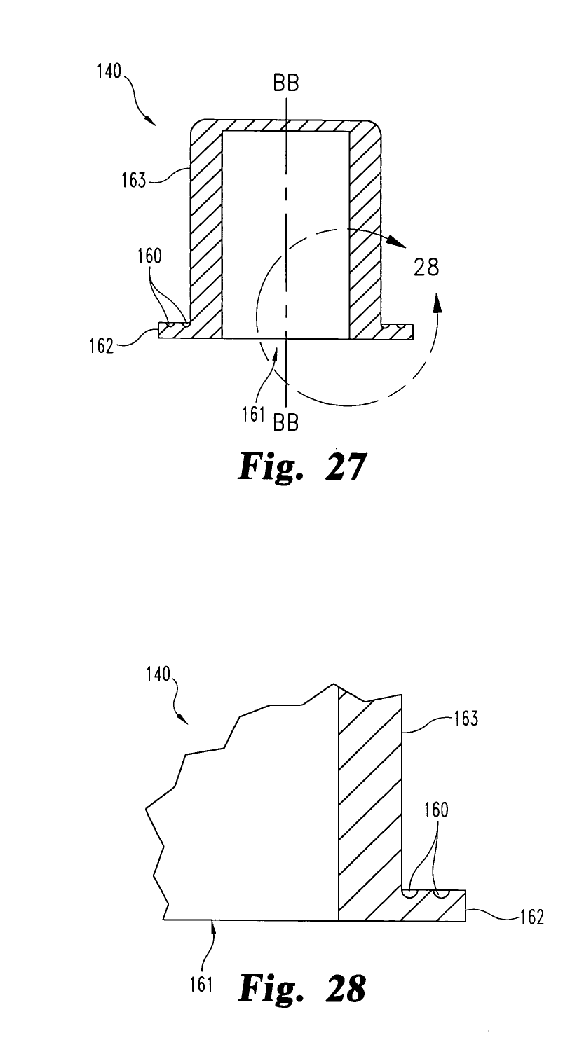

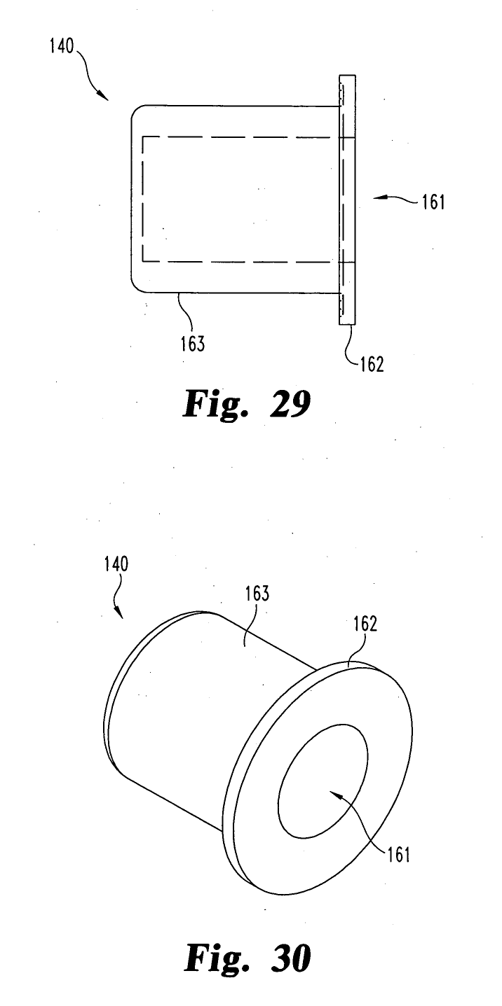

With reference to FIGS. 26-30 there are shown multiple views of centering cap 140 which is also illustrated and described above in connection with FIGS. 1-10. As shown in FIGS. 26-30 cap 140 includes cap body 163, cap flange 162, sealing rings 160, and cap cavity 161. Cap cavity 161 receives magnet 150 and an end portion of pole piece 130, as illustrated and described above. Cap body 163, cap flange 162 and cap cavity 161 have generally circular cross sectional shapes for sections taken perpendicular to axis BB shown in FIG. 27.

A preferred embodiment of cap 140 according to the present invention can be manufactured to dimensions and tolerances which allow magnet 150 and an end portion of pole piece 130 to fit snugly within cavity 161. These dimensions and tolerances are merely exemplary of one preferred embodiment, however, and centering caps of a variety of different configurations, sizes, dimensions, and tolerances are contemplated as within the scope of the invention.

Caps 140 and 240 are preferably formed from a resin material adapted for use in an injection molding system, most preferably of Zytel #70G43L NC010 resin which is a 43% glass filled, natural colored polyamide 6/6 grade nylon material available from DuPont corporation of Wilmington, Del. It is also contemplated that caps 140 and 240 could be formed from a variety of other materials, for example, other grades of Zytel with different glass contents, copolymers or colors, 4/6 grades of polyamide such as DSM Stanyl TW241F10 or others, other members of the polyamide family of resins including other 4/6 and 6/6 grades, other materials having similar properties, other plastics, thermoplastics, epoxy resins, and/or other materials suitable to maintain their integrity in an injection molding environment. In one embodiment according to the present invention, caps 140 and 240 are formed from a conductive thermoplastic material.

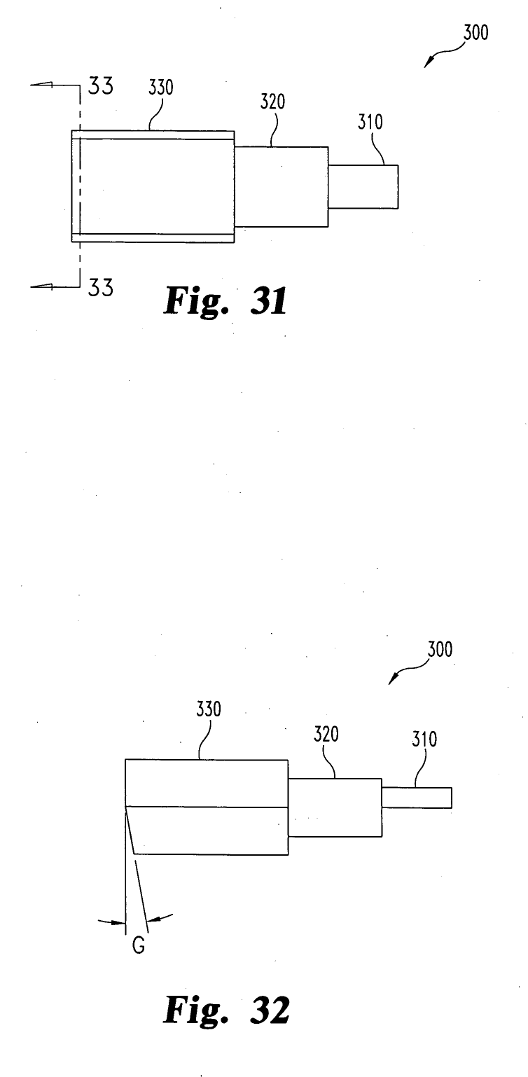

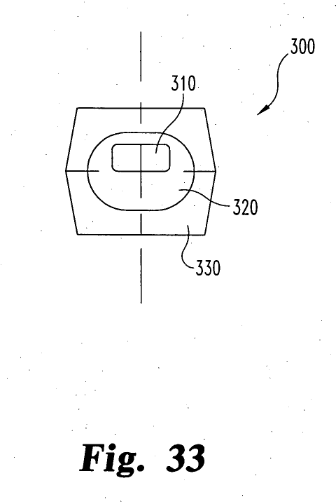

With reference to FIGS. 31-33 there are shown multiple views of locating plug 300 according to an embodiment of the present invention. Locating plug 300 includes tip portion 310, middle portion 320 and body 330. Tip portion and middle portion of locator plug 300 are preferably adapted to be inserted into and substantially or completely fill cavity 170 of sensor 99 or cavity 270 of sensor 199 which were described above, or to be inserted into and substantially or completely fill sensors cavities of a variety of other configurations, sizes, dimensions and tolerances. Plug 300 is preferably used in connection with the manufacturing of a sensor according to the present invention such as, for example, sensors 99 and 199 which are described above.

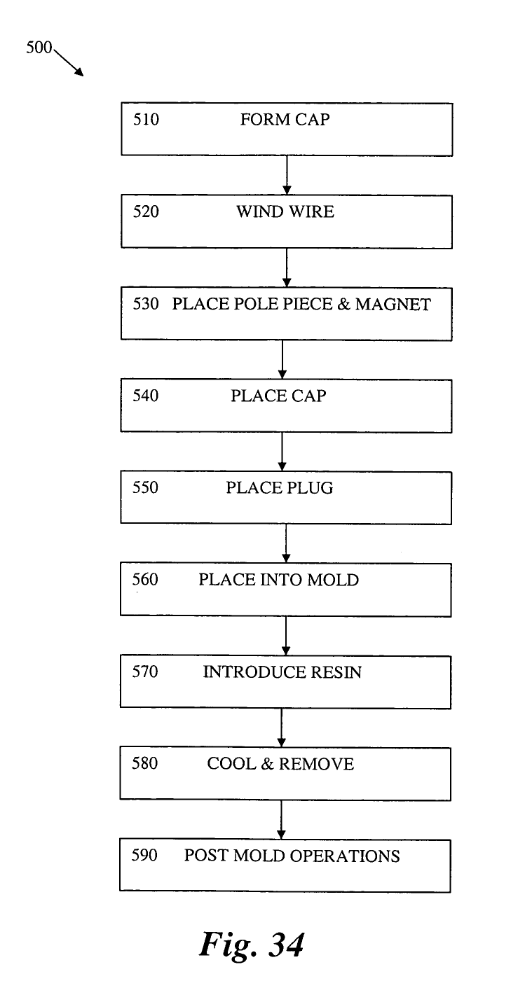

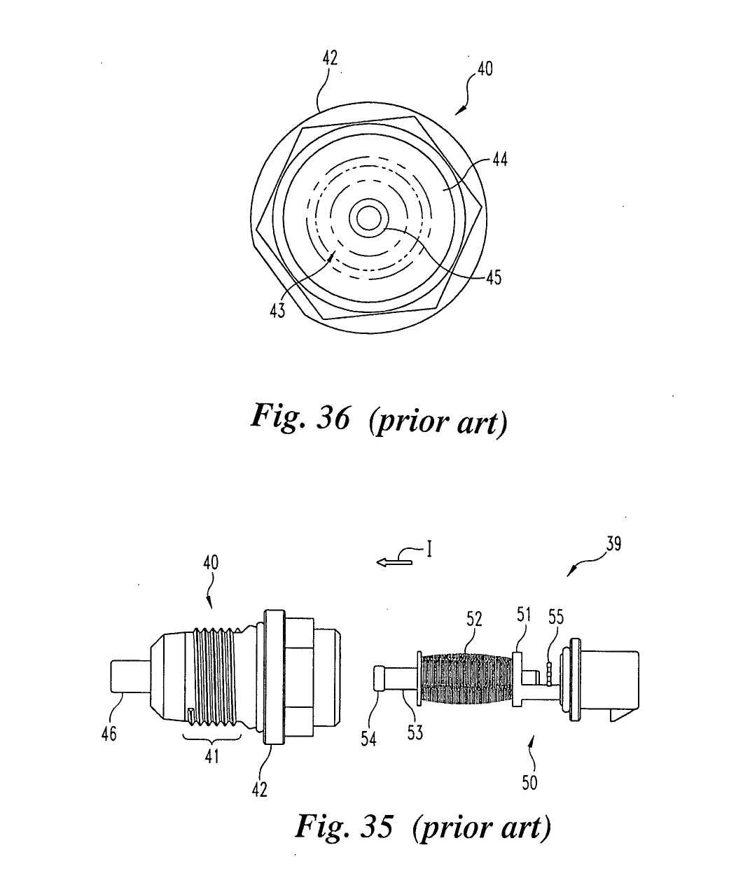

With reference to FIG. 34 there is shown flow diagram 500 according to a preferred embodiment of the present invention. Sensors according to the present invention, for example, sensors 99 and 199 described above and other sensors can be manufactured according to the manufacturing process of flow diagram 500. For clarity flow diagram 500 is described using the reference numerals associated with sensor 99, but similar or identical manufacturing operations could also be performed for sensor 199 and other sensors according to the present invention. At operation 510 centering cap 140 is formed as a single piece preferably using an injection molding technique and preferably using one or more materials described above in connection with FIGS. 26-30. It is contemplated however that cap 140 could be formed using a variety of other techniques, processes, and materials. From operation 510 flow diagram proceeds to operation 520.

At operation 520 wire 110 is wound around bobbin 120 and end portions of wire 110 are soldered to pin terminals 141 and 142. Bobbin 140 could be formed by injection molding, other molding techniques, or using any other technique known to those of skill in the art. It is also contemplated that wire 110 and bobbin 120 could be provided as a preassembled unit. From operation 520 flow diagram proceeds to operation 530.

At operation 530, pole piece 130 is inserted into bobbin 120 and magnet 150 is placed at the end of pole piece 130. It is also contemplated that pole piece 130 and/or magnet 150 could be provided as part of a preassembled unit. From operation 530 flow diagram proceeds to operation 540.

At operation 540 centering cap 140 is placed over magnet 150 and an end portion of pole piece 130 so that its end surface contacts the end surface of bobbin 120. It is also contemplated that centering cap 140 could be provided as part of a preassembled unit. Furthermore, it is contemplated that one or more of operations 510, 520, 530 and 540 could be performed as a single operation, could be performed in parallel, in series or a combinations of parallel and serial operations, or could be broken into sub-operations including additional separate steps. From operation 540, flow diagram proceeds to operation 550.

At operation 550, locating plug 300 is inserted into cavity 170 at the terminal end of bobbin 120 and substantially or completely fills cavity 170, or fills a portion of cavity 170 and is effective to prevent resin from filling cavity 170 during injection molding and to support and maintain the position of the other components within a mold. From operation 550, flow diagram 500 proceeds to operation 560.

At operation 560 the assembly including cap 140, magnet 150, pole piece 130, bobbin 120 wire 110 and plug 300 is placed into a mold. The mold is preferably a book mold, and the assembly is placed into one half of the book mold and the other half of the book mold is closed over the assembly. The mold defines a cavity having the shape of overmolded resign shell 100. Centering cap 140 and plug 300 support the assembly within the mold and maintain it in a position such that the assembly is spaced away from the interior surfaces of the mold. Thus, there is a void in the area between the inside surface of the mold and the outer region of the assembly. This void extends along the length of the assembly from before the sealing rings 160 of the locating cap 140 up to about the portion of bobbin 120 which is visible in FIG. 1. From operation 560, flow diagram 500 proceeds to operation 570.

At operation 570, molten resin is introduced into the mold under pressure and is forced to fill the void defined by any space not occupied by the assembly and/or plug. Introduction of molten resin is preferably accomplished using a rotary table rotating beneath an injection molding machine that injects the resin into the cavity of the book mold through various gates or ports formed in the book mold. From operation 570, flow diagram 500 proceeds to operation 580.

At operation 580, the molten resin cools within the sensor assembly with the overmolded resin shell is removed from the mold after an appropriate cooling period. From operation 580, flow diagram proceeds to operation 590.

At operation 590 quality control procedures may be performed on the sensor. Additional post-mold procedures, such as addition of O-ring 180, polishing, trimming or otherwise removing molding artifacts can also be performed.

After operation 590, the sensor is in a finished or substantially finished state. In the finished state resin shell 100 preferably hermetically encapsulates and supports all portions of the assembly not visible outside shell 100 as shown in FIG. 1. Seals are preferably formed between shell 100 and sealing rings 160 and between shell 100 and the bobbin sealing flanges located under top portion 104 as shown in FIG. 8. Thus, pole piece 130, magnet 150, wire 110, pin terminals 141 and 142, and portions of bobbin 120 are preferably hermetically encapsulated, contacted and supported by the overmolded resin shell 100. Furthermore, overmolded resin shell 100 holds locating cap 140 in a position relative to the assembly as shown and described above in connection with FIGS. 1-10.

A number of variations of the foregoing manufacturing process and devices are contemplated. For example, it is contemplated that two or more of the foregoing operations could be performed as a single operation, could be performed in parallel, in series or a combinations of parallel and serial operations, or that one or more of the foregoing operations could be broken into sub-operations including additional separate steps. It is also contemplated that one or more of the foregoing operations could be omitted, for example, operation 590 or other operations. It is further contemplated that additional operations could be interposed between the operations described above. Furthermore, it is contemplated that a centering cap could be omitted from the assembly that is introduced into the mold and the injected resin could form the structure of the assembly cap. According to this process overmolded resin shells 100 and 200 described above constitute the structure of caps 140 and 240, respectively. This process reduces the number of parts of the assembly that is inserted into the mold. The absence of centering cap may result in undesired displacement of the magnet or other parts. Thus, it is contemplated that a thin sleeve could be used to hold the magnet in place relative to the pole piece during molding. It is also contemplated that a variety of molds and injection molding techniques could be utilized in addition to those discussed above. It is also contemplated that a thin sleeve or ring with 2 or more tabs could be located on the tip of the sensor at 130 or 150. These tabs would center the sensor within the mold, allowing the overmolded resin shells 100 and 200 to constitute the structure of the caps 140 and 240, respectively, except in the areas where the tabs contact the mold.

As used herein terms relating to properties such as geometries, shapes, sizes, and physical configurations, include properties that are substantially or about the same or equal to the properties described unless explicitly indicated to the contrary.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed is:

1. A transmission sensor comprising:
a bobbin including a first region adapted to receive windings and a second region defining a cavity formed in the bobbin;
a first electrical terminal coupled to the bobbin and disposed in the cavity;
a second electrical terminal coupled to the bobbin and disposed in the cavity;
a wire including a wound portion wound about the first region, the wire conductively coupled to the first terminal and the second terminal to provide an electrically conductive pathway from the first terminal to the second terminal;
a magnetizable core disposed at least partially within the wound portion;
a magnet positioned adjacent the magnetizable core; and
an overmolded shell defining an exterior surface of the sensor and encapsulating at least the first region and the wound portion and contacting at least the wound portion.

2. The sensor of claim 1 wherein the overmolded shell includes threads formed on the outermost surface of the shell.

3. The sensor of claim 1 wherein the overmolded shell is formed of a polyamide resin.

4. The sensor of claim 1 wherein the wire further comprises a first and second lead portions extending from the wound portion and the overmolded shell encapsulates and contacts the first and second lead portions.

5. The sensor of claim 1 wherein overmolded shell encapsulates a region of the second portion but does not encapsulate or obstruct the cavity.

6. The sensor of claim 5 wherein the first region and the second region are spaced apart along a longitudinal axis of the bobbin.

7. A method of manufacturing a transmission sensor comprising:
providing an assembly including a bobbin having a cavity formed in the bobbin, a wire including a wound portion wound about the bobbin, a magnetizable core disposed at least partially within the wound portion, and a magnet positioned adjacent the magnetizable core;
inserting a plug into the cavity;
positioning the plug and the assembly into a mold;
introducing resin into the mold effective to encapsulate the sensor assembly;
first removing the plug and the assembly from the mold; and
second removing the plug.

8. The method of claim 7 wherein the mold is a book mold and further comprising closing the book mold about the plug and the assembly.

9. The method of claim 7 wherein the resin is a polyamide resin.

10. The method of claim 7 wherein the wire is a coated wire.

11. The method claim 1 wherein the introducing utilizes injection molding.

12. The method of claim 11 wherein the injection molding includes rotating the mold relative to a resin injector effective to inject resin through one or more ports defined in the mold.

13. A method of overmolding a resin shell about a variable reluctance transmission sensor assembly including a bobbin, a conductor wound about the bobbin, and an aperture defined at an end of the bobbin, comprising:
connecting a positioning tool to the assembly at the aperture;
placing the assembly and the positioning tool in a mold;
maintaining the position of the assembly using the tool;
introducing resin into the mold; and
allowing the resin to set;
wherein the introducing is effective to substantially hermetically encapsulate a portion of the assembly excluding the aperture and to form an outermost surface of the sensor.

14. The method of claim 13 wherein the resin is a polyamide resin.

15. The method of claim 13 wherein the introducing is effective to define threads on the outermost surface.

16. The method of claim 13 wherein the introducing is effective to define a stopping flange on the outermost surface.

17. The method of claim 13 wherein the conductor is a coated wire.

18. The method of claim 13 wherein resin introduced into the mold is heated resin and the allowing the resin to set includes cooling the resin.

19. The method of claim 13 wherein the introducing resin into the mold utilizes injection molding.

20. The method of claim 13 wherein the mold is a book mold and further comprising closing the book mold about the assembly and the tool.
